(19) United States
(12) Patent Application Publication
(10) Pub. No.: US 2026/0281708 A1
(43) Pub. Date: Sep. 17, 2026

(54) ARTIFICIAL INTELLIGENCE CAPABILITY REPORTING METHOD AND APPARATUS

(71) Applicant: 1FINITY Inc., Kawasaki-shi (JP)

(72) Inventor: Tingting GENG, Beijing (CN)

(73) Assignee: 1FINITY Inc., Kawasaki-shI (JP)

(21) Appl. No.: 19/673,452

(22) Filed: May 11, 2026

Related U.S. Application Data
(63) Continuation of application No. PCT/CN2023/132340, filed on Nov. 17, 2023.

(51) Int. Cl. H04W 8/24

(52) U.S. Cl. CPC H04W 8/24

(57) ABSTRACT

An artificial intelligence (AI) capability reporting method and apparatus. The method includes: transmitting report information by a terminal equipment to a first network device, the report information including AI capability information of a first cell; or, transmitting a fourth message by a core network device to a first network device, the fourth message including AI capability information related to a second network device.

### CROSS-REFERENCE TO RELATED APPLICATION

This application is a continuation application under 35 U.S.C. 111 (a) of International Patent Application PCT/CN2023/132340 filed on Nov. 17, 2023, and designated the U.S., the entire contents of which are incorporated herein by reference.

### TECHNICAL FIELD

This disclosure relates to the field of communication technologies.

### BACKGROUND

Multiple scenarios or sub-scenarios are defined in an artificial intelligence/machine learning (AI/ML) project in 3GPP R18, such as CSI enhancement (which may also include at least one sub-scenario in CSI compression and CSI prediction), beam management, positioning, or other scenarios. Different scenarios or sub-scenarios may correspond to one or more features/feature groups. Application of AI/ML to the above feature/feature group is referred to as AI/ML-based/enabled feature/feature group. An AI/ML-based/enabled feature/feature group may correspond to one or more AI functionalities and/or one or more AI models. One AI functionality may further correspond to one or more AI models, and the functionality refers to an AI/ML-based/enabled feature/feature group configured to be enabled. A possible logic is shown in FIG. 1.

Life cycle management (LCM) to which an AI/ML-based/enabled feature/feature group correspond(s) may be divided into functionality based LCM and model-ID based LCM according to whether it is a functionality granularity or a model-ID granularity. The LCM may include at least one of the following: data collection, model training, model inference, model monitoring, model/functionality control, model update, model transmission/delivery, model storage, UE capability reporting, or other processes. The model/functionality control may include at least one of the following AI operations: selection, activation, deactivation, switching or change, fallback, release, or other operations of a model/functionality. The fallback refers to falling back to a mode in which AI is not applied.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that after the introduction of AI/ML, there may possibly exist cases where some network devices support AI/ML while some other network devices do not support AI/ML, or different network devices support different AI/ML-related capabilities. In existing methods, a network device is unable to learn AI/ML-related capabilities of other network devices. For example, when a terminal equipment needs to be switched to another network device, a preferable target cell may not be selectable for the terminal equipment.

In order to solve at least one of the above problems or other similar problems, embodiments of this disclosure provide an AI capability reporting method and apparatus and a communication system.

According to one aspect of the embodiments of this disclosure, there is provided an AI capability reporting apparatus, configured in a terminal equipment (UE), wherein the apparatus includes:
a transmitting unit configured to transmit report information to a first network device, the report information including AI capability information of a first cell.

According to another aspect of the embodiments of this disclosure, there is provided an AI capability reporting apparatus, configured in a first network device, wherein the apparatus includes:
a receiving unit configured to receive report information transmitted by a terminal equipment, the report information including AI capability information of a first cell, or configured to receive a fourth message transmitted by a core network device, the fourth message including AI capability information related to a second network device.

According to a further aspect of embodiments of this disclosure, there is provided an artificial intelligence (AI) capability reporting apparatus, configured in a core network device, wherein the apparatus includes:
a transmitting unit configured to transmit a fourth message to a first network device, the fourth message including AI capability information related to a second network device.

An advantage of the embodiments of this disclosure is that according to the embodiments of this disclosure, the network device may acquire AI capability information related to a neighbor network device that has no direct interface via the terminal equipment or the core network device, so that an appropriate target cell is selected for the terminal equipment in mobility of the terminal equipment supporting AI, and the AI functionalities of the terminal equipment may be enabled as much as possible.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the invention may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a logical schematic diagram of an AI functionality and its corresponding AI model;

FIG. 2 is a schematic diagram of an AI capability reporting method of embodiments of this disclosure;

FIG. 3 is a schematic diagram of an AI capability reporting method of embodiments of this disclosure;

FIG. 4 is an interaction diagram of the AI capability reporting method of the embodiments of this disclosure;

FIG. 5 is an interaction diagram of the AI capability reporting method of the embodiments of this disclosure;

FIG. 6 is a schematic diagram of an AI capability reporting method of embodiments of this disclosure;

FIG. 7 is a schematic diagram of an AI capability reporting method of embodiments of this disclosure;

FIG. 8 is a schematic diagram of an AI capability reporting method of embodiments of this disclosure;

FIG. 9 is an interaction diagram of the AI capability reporting method of the embodiments of this disclosure;

FIG. 10 is a schematic diagram of an AI capability reporting apparatus of embodiments of this disclosure;

FIG. 11 is a schematic diagram of an AI capability reporting apparatus of embodiments of this disclosure;

FIG. 12 is a schematic diagram of a communication system of embodiments of this disclosure;

FIG. 13 is a schematic diagram of a terminal equipment of the embodiments of this disclosure; and

FIG. 14 is a schematic diagram of a network device of the embodiments of this disclosure.

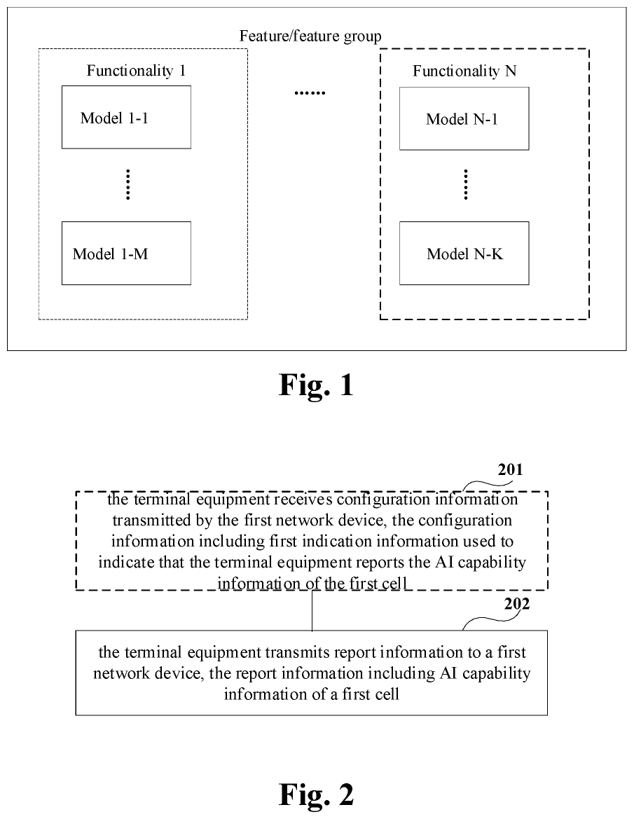

### DETAILED DESCRIPTION OF THE DISCLOSURE

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, scenarios containing a network device and/or a terminal equipment are taken as examples.

In the above scenarios, the network device may include at least one of a core network device, a third-party application device, operation administration and maintenance (OAM), and an access network device.

The core network device may refer to a device in a core network (CN) providing service support to a terminal equipment. As some instances, the core network device may be at least one of the following: a mobility and management entity (MME), an access and mobility management function (AMF) entity, a session management function (SMF) entity, a user plane function (UPF) entity, and a location management function (LMF) entity, etc., which shall not be enumerated herein any further. The AMF entity may be responsible for access management and mobility management of a terminal, the SMF entity may be responsible for session management, such as establishment of a user session, and the UPF entity may be a functional entity of a user plane, and is mainly responsible for connection to external networks. The LMF entity may manage overall coordination and scheduling of resources needed by a location of a terminal equipment registered to the core network device or accessed to the core network device. It should be noted that in this disclosure, an entity may also be referred to as a network element or a functional entity, for example, the AMF entity may also be referred to as an AMF network element or an AMF functional entity, etc.

The third-party application device may be an OTT server (over the top server) or another third-party device.

The OAM may be a network device that performs operations, administration, maintenance, and other management tasks on the network according to actual needs of network operations of an operator.

The access network device is an access device of a terminal that accesses to a communication system in a wireless manner. The access network device may be a base station (BS), an evolved base station (evolved NodeB, eNodeB), a transmission reception point (TRP), a base station in a fifth generation (5G) mobile communication system (next generation NodeB, gNB), a base stations in a sixth generation (6G) mobile communication system, a base station in a future mobile communication system or access node in a WiFi system, etc.; the access network device may also be a module or unit that completes a part of functions of a base station, for example, it may be at least one of the following modules or units: a centralized unit (CU), a distributed unit (DU), a centralized unit control plane (CU-CP), a centralized unit user plane (CU-CP), an integrated access backhaul (IAB), or other modules or units. Specific techniques and/or specific device forms adopted by the access network device are not limited in the embodiments of this disclosure. The access network device may be deployed on the land, including indoors/outdoors, and may be handheld or on-board; and it may also be deployed on a water surface, an airplane, a balloon or a satellite. The access network device may be deployed at a fixed position or on a mobile carrier, which is not limited in the embodiments of this disclosure.

In the above scenarios, the terminal equipment is an equipment having a function of wireless transmission and reception, and may transmit signals to the access network device and/or receive signals from the access network device. The terminal equipment may also be referred to as a terminal, a mobile station, and a mobile terminal, etc. The terminal equipment may be a mobile phone, a tablet, or other equipments having a function of wireless intelligent transmission and reception. The terminal equipment may be widely used in various scenarios, such as device-to-device (D2D), vehicle to everything (V2X) communication, machine-type communication (MTC), Internet of Things (IoT), virtual reality, augmented reality, industrial control, autonomous driving, telemedicine, or various intelligent scenarios.

In the above scenarios, communication may be performed between the access network device and the terminal equipment and between terminal equipments via licensed spectrum or via unlicensed spectrum, or via licensed spectrum and unlicensed spectrum simultaneously. Spectrum resources used in the wireless communication are not limited in the embodiments of this disclosure.

In the following description of this disclosure, artificial intelligence (AI) may also be referred to as artificial intelligence/machine learning (AI/ML) or machine learning (ML), and these terms are interchangeable. For example, “an AI-based feature or feature group” and “an AI/ML-based feature or feature group” have identical meanings, and their corresponding English words may be AI/ML-based feature/FG.

The embodiments of this disclosure shall be described below with reference to the accompanying drawings and implementations. For ease of description, following description shall be given by taking a base station serving as an access network device as an example. In the following description, without causing confusion, “if . . . ”, “in a case where . . . ” and “when . . . ” are interchangeable.

### Embodiments of a First Aspect

The embodiments of this disclosure provide an AI capability reporting method, which shall be described from a terminal equipment side.

FIG. 2 is a schematic diagram of the AI capability reporting method of the embodiments of this disclosure. As shown in FIG. 2, the method includes:
202: the terminal equipment transmits report information to a first network device, the report information including AI capability information of a first cell.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

According to the embodiments of this disclosure, no interface exists between a network device and a neighbor network device, hence, AI capability information is unable to be directly exchanged via an interface. The network device may acquire AI capability information related to a neighbor network device that has no direct interface with assistance of the terminal equipment, so that an appropriate target cell is selected for the terminal equipment in mobility of the terminal equipment supporting AI, and the AI functionalities of the terminal equipment may be enabled as much as possible.

In some embodiments, the AI capability information includes at least one piece of the following information: support information of artificial intelligence; support information of at least one AI-based feature or feature group; support information of at least one functionality; support information of at least one model; association information of an AI-based feature or feature group and a functionality and/or a model; and support information of at least one model transmission method. Various types of the above AI capability information shall be described below.

For example, the support information of AI is used to indicate whether a current cell supports artificial intelligence. The support information of AI may be represented by a 1-bit information element. When the AI capability information includes the information element, it indicates that AI is supported, and when the AI capability information does not include the information element, it indicates that AI is not supported. Or, when a bit value of the information element is a first value, it indicates that AI is supported, and when the bit value is a second value, it indicates that AI is not supported. The first value may be 1 and the second value may be 0, or the first value may be 0 and the second value may be 1, and the embodiments of this disclosure are not limited thereto.

For example, support information of at least one AI-based feature or feature group is used to indicate whether a cell supports the AI-based feature or feature group. For example, when identification information of a feature or feature group appears in the AI capability information, it indicates that a corresponding feature or feature group identified by the identification information is supported, and when identification information of a feature or feature group does not appear, it indicates that a corresponding feature or feature group is not supported. The identification information of the feature or feature group may be an index, an identifier, a name, or other information.

For example, support information of at least one functionality is used to indicate whether a current cell supports the functionality, or is used to indicate whether a current cell supports the functionality under an AI-based feature or feature group. Optionally, the functionality may be indicated by identification information of the functionality. The identification information of the functionality may be an index, an identifier, a name, or other information. For example, when identification information of the functionality appears in the AI capability information, it indicates that a corresponding functionality identified by the identification information is supported, and when identification information of a functionality does not appear, it indicates that a corresponding functionality is not supported.

For example, support information of at least one model is used to indicate whether a current cell supports the model, or is used to indicate whether a current cell supports the model under a functionality under an AI-based feature or feature group, or is used to indicate whether a current cell supports the model under an AI-based feature or feature group. Optionally, a model may be indicated by identification information of the model. The identification information of the model may be an index, an identifier, a name, or other information.

For example, when identification information of a model appears in the AI capability information, it indicates that a corresponding model identified by the identification information is supported, and when identification information of a model does not appear, it indicates that a corresponding model is not supported.

For example, the association information of an AI-based feature or feature group and a functionality and/or a model is used to indicate association information of a feature or feature group and a functionality, and/or is used to indicate association information of a feature or feature group and a model, and/or is used to indicate an association of a feature or feature group, a functionality and a model.

The above AI capability information is illustrated below:

### Example 1

AI capability information
> feature/FG X
>> functionality Y
>>> model Z

In Example 1, it indicates that the current cell supports model Z under functionality Y under AI-based feature or feature group X, and indirectly indicates association information of X, Y and Z.

### Example 2

AI capability information
> functionality Y
Association information: functionality
Y -> feature/FG X

In Example 2, the association information directly indicates that feature or feature group X and functionality Y are associated. Functionality Y indicates that the current cell supports functionality Y. With the association information, it is determined that the current cell supports functionality Y under AI-based feature or feature group X, which shall not be illustrated herein one by one any further.

For example, the support information of at least one model transmission method may be used to indicate model transmission method information supported by a cell, wherein the model transmission method may include at least one of the following methods: model transmission based on a control plane, model transmission based on a user plane, segmented transmission, transmission from a network device to a terminal equipment, and transmission from a terminal equipment to a network device, etc. Correspondingly, support information of at least one model transmission method is used to indicate whether a current cell supports the above at least one method. The support information of the at least one model transmission method may be represented by a bit string, in which different bits correspond to different model transmission methods, and values of the bits are used to indicate whether corresponding model transmission methods are supported. For example, when the bit string is set to be a specific value (such as 000), it indicates that no model transmission method is supported, and when the bit string is set to be 001, it indicates that model transmission based on a control plane is supported, and so on, which shall not be illustrated one by one herein any further; however, the embodiments of this disclosure are not limited thereto.

In some embodiments, the report information may further include cell information of the first cell. The cell information includes at least one piece of the following information: a cell global identifier (CGI), a physical cell identifier (PCI) and frequency point information, a cell identifier (cell ID), a non-public network identifier (NPN ID), a non-terrestrial network identifier (NTN ID), or one of other cell identifiers. The CGI may include a public land mobile network identifier (PLMN ID) and a cell ID. Optionally, the cell information may further include a tracking area code (TAC) and/or identification information of a network device to which the cell belongs, such as a global network device identifier.

In some embodiments, the first cell is a neighbor cell of a serving cell of the terminal equipment, and the first cell and the serving cell may be cells under different network devices. For example, the serving cell is a cell under the first network device, and the first cell is a cell under a second network device different from the first network device. The first cell may include one cell or more cells, and embodiments of this disclosure is not limited thereto.

In some embodiments, optionally, the method may further include:
201: the terminal equipment receives, configuration information transmitted by the first network device, the configuration information including first indication information used to indicate that the terminal equipment reports the AI capability information of the first cell.

In some embodiments, optionally, the configuration information may further include cell information of the first cell, implementations of which being as described above, and being not going to be repeated herein any further. According to the cell information in the configuration information, the terminal equipment determines AI capability information of which cell (first cell) is acquired and/or reported.

In some embodiments, optionally, the configuration information may further include second indication information used to indicate AI capability information that the terminal equipment needs to report. According to the second indication information, the terminal equipment may be made to report AI capability information of a cell of interest of the first network device, thereby reducing unnecessary signaling overhead. For example, when the second indication information includes an information element of a feature or feature group, the second indication information is used to indicate that the AI capability information reported by the terminal equipment includes support information of at least one AI-based feature or feature group. Correspondingly, the terminal equipment may report support information of the first cell for the at least one AI-based feature or feature group. For example, when the second indication information includes an information element of a model, the second indication information is used to indicate that the AI capability information reported by the terminal equipment includes support information of at least one model, and correspondingly, the terminal equipment may report support information of the first cell for the at least one model. For example, when the second indication information includes an information element of a functionality, the second indication information is used to indicate that the AI capability information reported by the terminal equipment includes support information of at least one functionality, and correspondingly, the terminal equipment may report support information of the first cell for the at least one functionality, which shall not described one by one herein, and the embodiments of this disclosure is not limited thereto. For example, a new bit string may also be designed, and different bit values correspond to different types of AI capability information or combinations of different types of AI capability information. A correspondence between bit values and different types of AI capability information or combinations thereof may be predetermined, and after receiving the second indication information, the terminal equipment may determine, according to the correspondence, which types of AI capability information are to be acquired and/or reported.

In some embodiments, optionally, the embodiments of this disclosure may further include step 200 (not shown): the first network device acquires first UE capability information of the terminal equipment, the first UE capability information being used to indicate whether the terminal equipment supports a capability to acquire AI capability information of a cell.

As one possible implementation, when the first UE capability information indicates that the terminal equipment supports acquiring AI capability information of a cell, or the first UE capability information indicates that the terminal equipment has a capability to acquire AI capability information of a cell, operation 201 is performed in the embodiments of this disclosure. It may be understood that the embodiments of this disclosure are not limited thereto. The first UE capability information may be represented by a 1-bit information element. When the information element is included, it indicates that acquiring AI capability information of a cell is supported; and/or, when the information element is not included, it indicates that acquiring AI capability information of a cell is not supported. Or, when a bit value of the information element is a first value, it indicates that acquiring AI capability information of a cell is supported; and/or, when the bit value is a second value, it indicates that acquiring AI capability information of a cell is not supported. As an example, the first value may be 1 and the second value may be 0; or, the first value may be 0 and the second value may be 1, and the embodiments of this disclosure are not limited thereto.

In some embodiments, the first network device may receive the first UE capability information transmitted by the terminal equipment; or the first network device may receive first UE capability information transmitted by a core network device or other access network devices, and the embodiments of this disclosure are not limited thereto.

In some embodiments, before transmitting the report information (i.e. step 202), the method may further include (not shown): a terminal equipment acquires the AI capability information of the first cell. The terminal equipment may acquire the AI capability information of the first cell according to or not according to the configuration information. The acquiring the AI capability information of the first cell includes: reading a system message of the first cell by the terminal equipment to acquire the AI capability information of the first cell carried by the system message. Or, the terminal equipment establishes connection with the first cell to acquire the AI capability information of the first cell through signaling interaction, or, the terminal equipment may store the AI capability information of the first cell.

In some embodiments, after the terminal equipment receives the first indication information, if the terminal equipment has already acquired the AI capability information of the first cell, the report information is transmitted to the terminal equipment according to the configuration information; or, after the terminal equipment receives the first indication information, if the terminal equipment has not yet acquired the AI capability information of the first cell, the AI capability information of the first cell is acquired according to the configuration information, and the report information is transmitted to the terminal equipment.

As one possible implementation, the terminal equipment may pre-store AI capability information of one or more neighbor cells of a serving cell, and after receiving the configuration information (the first indication information indicates that AI capability information of a cell is reported), the terminal equipment selects the first cell from the one or more neighbor cells according to cell information in the configuration information, and reports the AI capability information of the first cell to the first network device. Furthermore, according to the second indication information in the configuration information, the terminal equipment may select AI capability information of a first cell of interest of the first network device to report.

As another possible implementation, after receiving the configuration information (the first indication information indicates that AI capability information of a cell is reported), the terminal equipment reads a system message of the first cell according to cell information in the configuration information, so as to acquire the AI capability information of the first cell, and reports the AI capability information of the first cell to the first network device. Furthermore, the terminal equipment may read the system message of the first cell according to the second indication information, so as to acquire the AI capability information of the first cell of interest of the first network device, and report the AI capability information of the first cell of interest of the first network device to the first network device.

As a further possible implementation, after receiving the configuration information (the first indication information indicates that AI capability information of a cell is reported), the terminal equipment establishes connection with the first cell according to cell information in the configuration information, so as to acquire the AI capability information of the first cell and report the AI capability information of the first cell to the first network device. Furthermore, the terminal equipment may acquire AI capability information of a first cell of interest of the first network device according to the second indication information, and report the AI capability information of the first cell of interest of the first network device to the first network device.

The AI capability reporting method is described above from the terminal equipment side.

The embodiments of this disclosure further provide an AI capability reporting method, which shall be described from a first network device side.

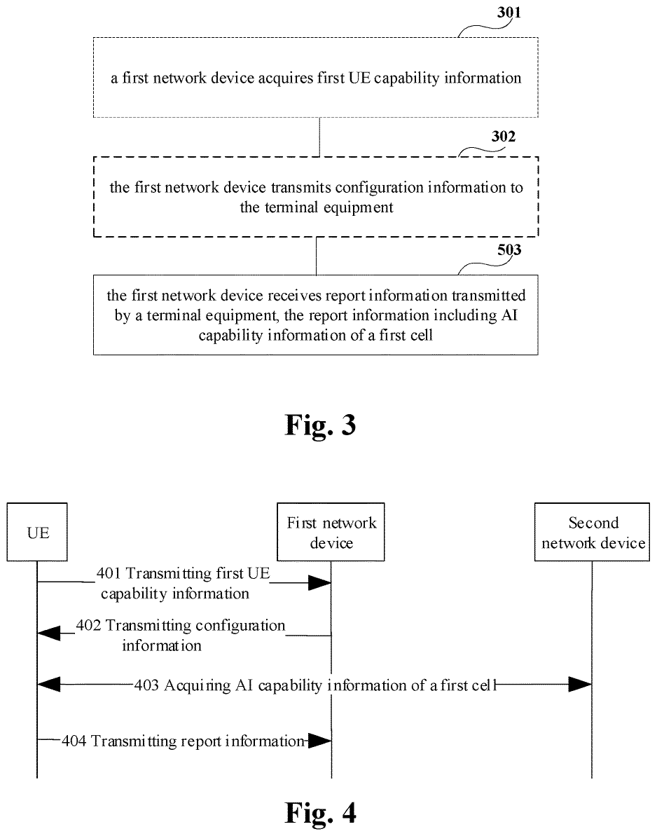

FIG. 3 is a schematic diagram of the AI capability reporting method of the embodiments of this disclosure. As shown in FIG. 3, the method includes:
303: the first network device receives, report information transmitted by a terminal equipment, the report information including AI capability information of a first cell.

Reference may be made to the description of step 202 for an implementation of step 303, which shall not be repeated herein any further.

In some embodiments, optionally, the method may further include:
301: the first network device acquires first UE capability information;
reference may be made to the description of step 200 for an implementation of step 301, which shall not be repeated herein any further;
302: the first network device transmits configuration information to the terminal equipment.

Reference may be made to the description of step 201 for an implementation of step 302, which shall not be repeated herein any further.

Implementations of steps 301-303 correspond to those at the terminal equipment side, and repeated parts shall not be described herein any further.

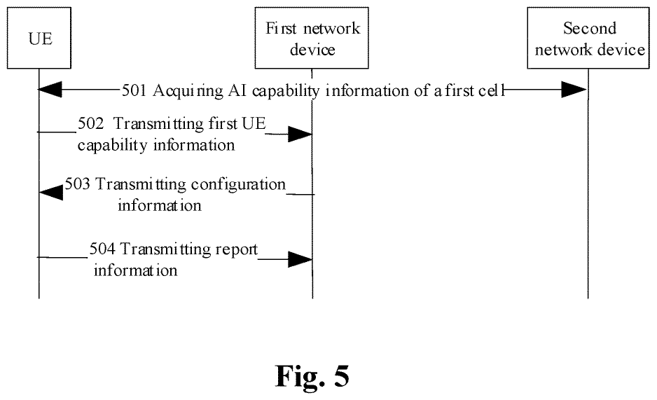

FIGS. 4 and 5 are interaction diagrams of the AI capability reporting method of the embodiments of this disclosure. As shown in FIG. 4, the method includes:
401: the terminal equipment transmits first UE capability information to the first network device;
reference may be made to the description of step 200 for an implementation of step 401, which shall not be repeated herein any further;
402: the first network device transmits configuration information to the terminal equipment;
reference may be made to the description of step 201 for an implementation of step 402, which shall not be repeated herein any further;
403: the terminal equipment acquires AI capability information of a first cell of a second network device according to the configuration information;
for example, in step 403, the terminal equipment reads a system message of the first cell according to the configuration information, so as to obtain the AI capability information of the first cell carried by the system message. Or, the terminal equipment establishes connection with the first cell, so as to acquire the AI capability information of the first cell through signaling interaction;
reference may be made to the related description of acquiring the AI capability information of the first cell by the terminal equipment in the embodiment to which FIG. 2 corresponds for specific description of step 403, which shall not be repeated herein any further;
404: the terminal equipment transmits report information to the first network device.

Reference may be made to the description of step 202 for an implementation of step 404, which shall not be repeated herein any further.

As shown in FIG. 5, the method includes:
501: the terminal equipment acquires AI capability information of a first cell of a second network device;
for example, in 501, the terminal equipment may pre-store AI capability information of one or more neighbor cells of serving cells.
reference may be made to the related description of acquiring the AI capability information of the first cell by the terminal equipment in FIG. 2 for an implementation of step 501, which shall not be repeated herein any further;
502: the terminal equipment transmits first UE capability information to the first network device;
reference may be made to the description of step 200 for an implementation of step 502, which shall not be repeated herein any further;
503: the first network device transmits configuration information to the terminal equipment;
reference may be made to the description of step 201 for an implementation of step 503, which shall not be repeated herein any further;
504: the terminal equipment transmits report information to the first network device according to the configuration information;
reference may be made to the description of step 202 for an implementation of step 504, which shall not be repeated herein any further.

Meanings of the first UE capability information, the configuration information, the AI capability information and the report information in FIGS. 4 and 5 are as described above, which shall not be repeated herein any further. The first UE capability information, the configuration information and the report information may be carried by RRC signaling and/or MAC CE signaling, and the embodiments of this disclosure are not limited thereto.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, no interface exists between a network device and a neighbor network device, hence, AI capability information is unable to be directly exchanged via an interface. The network device may acquire AI capability information related to a neighbor network device that has no direct interface with assistance of the terminal equipment, so that an appropriate target cell is selected for the terminal equipment in mobility of the terminal equipment supporting AI, and the AI functionalities of the terminal equipment may be enabled as much as possible.

### Embodiments of a Second Aspect

The embodiments of this disclosure provide an AI capability reporting method, which shall be described from a core network device side.

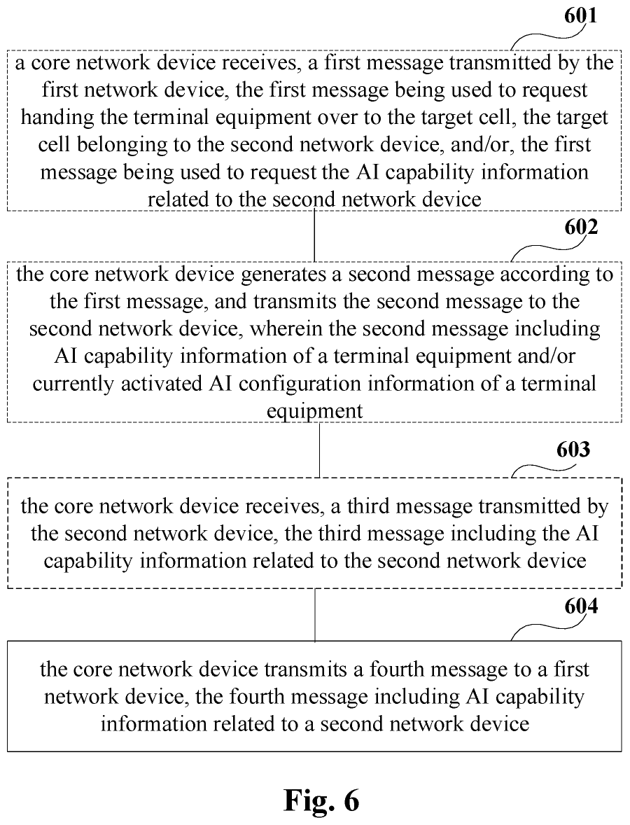

FIG. 6 is a schematic diagram of the AI capability reporting method of the embodiments of this disclosure. As shown in FIG. 6, the method includes:
604: the core network device transmits a fourth message to a first network device, the fourth message including AI capability information related to a second network device.

It should be noted that FIG. 6 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

According to the embodiments of this disclosure, no interface exists between a network device and a neighbor network device, hence, AI capability information is unable to be directly exchanged via an interface. The network device may acquire AI capability information related to a neighbor network device that has no direct interface with assistance of the core network device, so that an appropriate target cell is selected for the terminal equipment in mobility of the terminal equipment supporting AI, and the AI functionalities of the terminal equipment may be enabled as much as possible.

Optionally, the fourth message may further include identification information of the second network device. The identification information of the network device may be an ID of the network device or name information of the network device, such as a global node ID, a gNB-CU name, or other identification information of the network device.

In some embodiments, when a terminal equipment is switched from a serving cell under the first network device to a target cell under the second network device via the core network device, with the handover procedure, the network device may acquire AI capability information related to a neighbor network device having no direct interface with assistance of the core network device. How the core network device assists in acquiring the AI capability information related to a neighbor network device having no direct interface shall be described below by taking the handover procedure as an example. It should be noted that this disclosure is not limited to this handover procedure, and other existing or newly-established signaling interaction procedures may also be used to acquire the AI capability information related to a neighbor network device having no direct interface with the assistance of the core network device.

In some embodiments, the AI capability information includes at least one piece of the following information: support information of artificial intelligence; support information of at least one AI-based feature or feature group; support information of at least one functionality; support information of at least one model; association information of an AI-based feature or feature group and a functionality and/or a model; and support information of at least one model transmission method. The above types of AI capability information shall be described below.

For example, the support information of AI is used to indicate whether a current network device or a current cell or a current DU supports artificial intelligence. The support information of AI may be represented by a 1-bit information element. When the AI capability information includes the information element, it indicates that AI is supported, and when the AI capability information does not include the information element, it indicates that AI is not supported; or, when a bit value of the information element is a first value, it indicates that AI is supported, and when the bit value is a second value, it indicates that AI is not supported. The first value may be 1 and the second value may be 0, or the first value may be 0 and the second value may be 1, and the embodiments of this disclosure are not limited thereto.

For example, the support information of at least one AI-based feature or feature group is used to indicate whether a current network device or a current cell or a current DU supports the AI-based feature or feature group. For example, when identification information of a feature or feature group appears in the AI capability information, it indicates that a corresponding feature or feature group identified by the identification information is supported, and when identification information of a feature or feature group does not appear, it indicates that a corresponding feature or feature group is not supported. The identification information of the feature or feature group may be an index, an identifier, a name, or other information.

For example, the support information of at least one functionality is used to indicate whether a current network device or a current cell or a current DU supports the functionality, or is used to indicate whether a current network device or a current cell or a current DU supports the functionality under a certain AI-based feature or feature group. Optionally, the functionality may be indicated by identification information of the functionality. The identification information of the functionality may be an index, an identifier, a name, or other information. For example, when the identification information of the functionality appears in the AI capability information, it indicates that a corresponding functionality identified by the identification information is supported, and when the identification information of the functionality does not appear, it indicates that a corresponding functionality is not supported.

For example, the support information of at least one model is used to indicate whether a current network device or a current cell or a current DU supports the model, or is used to indicate whether a current network device or a current cell or a current DU supports the model under a certain functionality under a certain AI-based feature or feature group, or is used to indicate whether a current network device or a current cell or a current DU supports the model under a certain AI-based feature or feature group. Optionally, the model may be indicated by identification information of the model. The identification information of the model may be an index, an identifier, a name, or other information.

For example, when the identification information of the model appears in the AI capability information, it indicates that a corresponding model identified by the identification information is supported, and when the identification information of the model does not appear, it indicates that a corresponding model is not supported.

For example, the association information of an AI-based feature or feature group and a functionality and/or a model is used to indicate association information of a feature or feature group and a functionality, and/or is used to indicate association information of a feature or feature group and a model, and/or is used to indicate an association of a feature or feature group, a functionality and a model.

The above AI capability information is illustrated below:

### Example 1

AI capability information
> feature/FG X
>> functionality Y
>>> model Z

In Example 1, it indicates that the current cell supports model Z under functionality Y under AI-based feature or feature group X, and indirectly indicates association information of X, Y and Z.

### Example 2

AI capability information
> functionality Y
Association information: functionality
Y -> feature/FG X

In Example 2, the association information directly indicates that feature or feature group X and functionality Y are associated. Functionality Y indicates that the current cell supports functionality Y. With the association information, it is determined that the current cell supports functionality Y under AI-based feature or feature group X, which shall not be illustrated herein one by one any further.

For example, the support information of at least one model transmission method may be used to indicate model transmission method information supported by a network device or a cell or a DU, wherein the model transmission method may include at least one of the following methods: model transmission based on a control plane, model transmission based on a user plane, segmented transmission, transmission from a network device to a terminal equipment, and transmission from a terminal equipment to a network device, etc. Correspondingly, support information of at least one model transmission method is used to indicate whether a current cell supports the above at least one method. The support information of the at least one model transmission method may be represented by a bit string, in which different bits correspond to different model transmission methods, and values of the bits are used to indicate whether corresponding model transmission methods are supported. For example, when the bit string is set to be a specific value (such as 000), it indicates that no model transmission method is supported, and when the bit string is set to be 001, it indicates that model transmission based on a control plane is supported, and so on, which shall not be illustrated one by one herein any further; however, the embodiments of this disclosure are not limited thereto.

In some embodiments, the fourth message may further include cell information under the second network device, and/or, when the second network device is a CU, the fourth message may further include identification information of a DU under the second network device. The cell information includes at least one piece of the following information: a cell global identifier (CGI), a physical cell identifier (PCI) and frequency-point information, a cell identifier (cell ID), a non-public network identifier (NPN ID), a non-terrestrial network identifier (NTN ID), or at least one of other cell identifiers. The CGI may include a public land mobile network identifier (PLMN ID) and a cell ID. Optionally, the cell information may further include a tracking area code (TAC) and/or identification information of a network device to which the cell belongs, such as a global network device identifier. The identification information of the DU may be a DU ID and/or a DU name.

In some embodiments, the AI capability information may be of a cell level, or a DU level, or a network device level, wherein the AI capability information related to the second network device indicates AI capability information of a cell under the second network device, or AI capability information of a DU under the second network device, or AI capability information of the second network device.

For example, when the fourth message includes the AI capability information related to the second network device and cell information (cell ID 1), it indicates that the AI capability information is of the cell level and is used to indicate AI capability information of cell ID 1 under the second network device (indicating whether current cell ID 1 supports . . . ). When the fourth message includes the AI capability information related to the second network device and identification information of the DU (DU ID 1), it indicates that the AI capability information is of the DU level and is used to indicate AI capability information of DU ID 1 under the second network device (indicating whether current DU ID 1 supports . . . ). When the fourth message includes the AI capability information related to the second network device and the identification information of the network device, it indicates that the AI capability information is of the network device level and is used to indicate AI capability information of the second network device (indicating whether a current network device (the first network device) supports . . . ).

In some embodiments, the fourth message may be a handover command message or a handover failure message; however, the embodiments of this disclosure are not limited thereto. Optionally, when the fourth message is a handover failure message, the fourth message further includes handover failure cause information used to indicate a cause why the second network device does not successfully complete this time of handover. The handover failure cause information includes at least one configuration not supporting currently activated AI configuration information, or that the target cell does not support AI, or that AI resources of the target cell are insufficient, wherein the target cell belongs to the second network device.

How the core network device acquires the AI capability information related to the second network device shall be described below.

In some embodiments, optionally, the method may further include:
603: the core network device receives, a third message transmitted by the second network device, the third message including the AI capability information related to the second network device.

In some embodiments, the third message may further include cell information under the second network device and/or identification information of a DU under the second network device. The core network device may generate the fourth message based on the third message. Meanings of the AI capability information related to the second network device, the cell information and the identification information of the DU are as described above, which shall not be repeated herein any further.

In some embodiments, the third message may be a handover request acknowledge message or a handover preparation failure message; however, the embodiments of this disclosure are not limited thereto. Optionally, when the third message is a handover preparation failure message, the third message further includes handover failure cause information used to indicate a cause why the second network device does not successfully complete this time of handover. The handover failure cause information includes at least one configuration not supporting currently activated AI configuration information, or that the target cell does not support AI, or that AI resources of the target cell are insufficient, wherein the target cell belongs to the second network device.

In some embodiments, the method may further include:
601: the core network device receives, a first message transmitted by the first network device, the first message being used to request handing the terminal equipment over to the target cell, the target cell belonging to the second network device, and/or, the first message being used to request the AI capability information related to the second network device.

In some implementations, for example, when the first message is used to request handing the terminal equipment over to the target cell, the AI capability information of the terminal equipment may be carried in the first message so that the target cell may perform AI configuration on the terminal equipment after handover. A meaning of the AI capability information is as described above, except that, for example, the support information of AI is used to indicate whether the terminal equipment currently supports artificial intelligence. For example, the support information of at least one AI-based feature or feature group is used to indicate whether the terminal equipment currently supports the AI-based feature or feature group. The support information of at least one functionality is used to indicate whether the terminal equipment currently supports the functionality, or whether the terminal equipment currently supports the functionality under a certain AI-based feature or feature group. The support information of at least one model is used to indicate whether the terminal equipment currently supports the model, or whether the terminal equipment currently supports the model under a certain functionality under a certain AI-based feature or feature group, or whether the terminal equipment currently supports the model under a certain AI-based feature or feature group, which shall not be illustrated herein one by one.

In some implementations, the first message further includes currently activated AI configuration information of the terminal equipment. The activated AI configuration information includes at least one piece of the following information: activated AI/ML-based feature/feature-group information, activated functionality information, activated model information, AI/ML-based feature/feature-group information stored by the UE, functionality information stored by the UE, model information stored by the UE, UE calculating capability information, UE memory information, UE battery level information, or other information. The UE calculating capability information, UE memory information and the UE battery level information may be the above information recently acquired or determined or calculated by the first network device. As an example, the first message may include the following contents:

First message
>activated AI/ML-based feature/FG list
>> feature/FG1
>>> functionality list
> UE calculating capability information
> UE memory information

In some embodiments, the first message may be a handover required message; however, the embodiments of this disclosure are not limited thereto.

In some embodiments, the method may further include:
602: the core network device generates a second message according to the first message, and transmits the second message to the second network device, wherein the second message is used to request handing the terminal equipment over to a target cell, the target cell belonging to the second network device, and/or the second message is used to request the AI capability information related to the second network device.

As a possible implementation, the second message includes AI capability information of the terminal equipment. A meaning of the AI capability information of the terminal equipment is as described above, which shall not be repeated herein any further.

In some implementations, the second message further includes currently activated AI configuration information of the terminal equipment. A meaning of the currently activated AI configuration information is as described above, which shall not be repeated herein any further. Reference may be made to the description of step 601 for description related to step 602, which shall not be repeated herein any further.

The second message may be a handover request message; however, the embodiments of this disclosure are not limited thereto.

The AI capability reporting method is described above from the core network device side.

The embodiments of this disclosure further provide an AI capability reporting method, which shall be described from a first network device side.

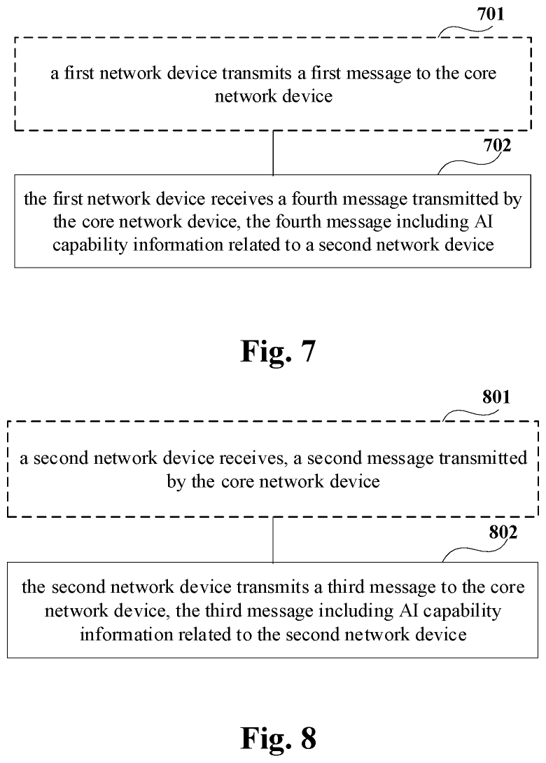

FIG. 7 is a schematic diagram of the AI capability reporting method of the embodiments of this disclosure. As shown in FIG. 7, the method includes:
702: the first network device receives, a fourth message transmitted by the core network device, the fourth message including AI capability information related to a second network device.

Reference may be made to the description of step 604 for implementation of step 702, which shall not be repeated herein any further.

In some embodiments, the method may further include:
701: the first network device transmits a first message to the core network device.

Reference may be made to the description of step 601 for implementation of step 701, which shall not be repeated herein any further.

Implementations of the first message and the fourth message are as described above, which shall not be repeated herein any further.

The embodiments of this disclosure further provide an AI capability reporting method, which shall be described from a second network device side.

FIG. 8 is a schematic diagram of the AI capability reporting method of the embodiments of this disclosure. As shown in FIG. 8, the method includes:
802: the second network device transmits a third message to the core network device, the third message including AI capability information related to the second network device.

Reference may be made to the description of step 603 for implementation of step 802, which shall not be repeated herein any further.

In some embodiments, the method may further include:
801: the second network device receives, a second message transmitted by the core network device.

Reference may be made to the description of step 602 for implementation of step 801, which shall not be repeated herein any further.

Implementations of the second message and the third message are as described above, which shall not be repeated herein any further.

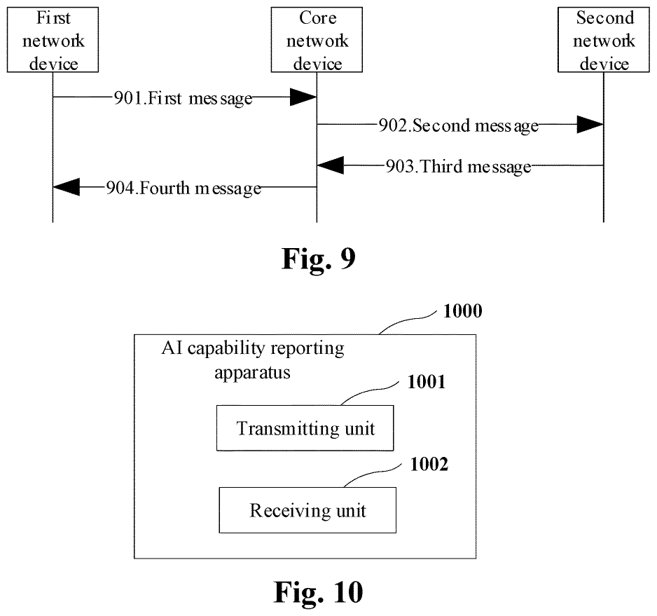

FIG. 9 is an interaction diagram of the AI capability reporting method of the embodiments of this disclosure. As shown in FIG. 9, the method includes:
901: the first network device transmits a first message to the core network device; reference may be made to the description of step 601 for implementation of step 901, which shall not be repeated herein any further;
902: the core network device generates a second message according to the first message, and transmits the second message to the second network device;
reference may be made to the description of step 602 for implementation of step 902, which shall not be repeated herein any further;
903: the second network device transmits a third message to the core network device;
reference may be made to the description of step 603 for implementation of step 903, which shall not be repeated herein any further;
904: the core network device generates a fourth message according to the third message, and transmits the fourth message to the first network device.

Reference may be made to the description of step 604 for implementation of step 904, which shall not be repeated herein any further.

Meanings of the first message, the second message, the third message and the fourth message are as described above, which shall not be repeated herein any further. It can be seen from the above embodiments that the core network device serves as a forwarding device, and may forward, via the second message, AI capability information of the terminal equipment and/or the currently activated AI configuration information of the terminal equipment, received from the first network device via the first message to the second network device, and may further forward, via the fourth message, the AI capability information related to the second network device received from the second network device via the third message to the first network device.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, no interface exists between a network device and a neighbor network device, hence, AI capability information is unable to be directly exchanged via an interface. The network device may acquire AI capability information related to a neighbor network device that has no direct interface with assistance of the core network device, so that an appropriate target cell is selected for the terminal equipment in mobility of the terminal equipment supporting AI, and the AI functionalities of the terminal equipment may be enabled as much as possible.

### Embodiments of a Third Aspect

The embodiments of this disclosure provide an AI capability reporting apparatus.

FIG. 10 is a schematic diagram of the AI capability reporting apparatus of the embodiments of this disclosure. The apparatus may be, for example, a network device, or one or some components or assemblies configured in the network device. As a principle of the apparatus for solving problems is identical to that of the method in the embodiments of first or the second aspect, reference may be made to the implementation of the method in the embodiments of the first or second aspect for implementation of this apparatus, with identical contents being not going to be repeated herein any further. As shown in FIG. 10, the apparatus 1000 includes: a transmitting unit 1001 and a receiving unit 1002.

In some embodiments, the apparatus is configured in the first network device in the embodiments of the first aspect. The receiving unit 1002 receives report information transmitted by a terminal equipment, the report information including AI capability information of a first cell. Optionally, the transmitting unit 1001 transmits configuration information to the terminal equipment, and the receiving unit 1002 further transmits first UE capability information to the first network device. The apparatus may further include an acquiring unit (not shown) configured to obtain AI capability information of the first cell. Or,

In some embodiments, the apparatus is configured in the core network device in the embodiments of the second aspect. The transmitting unit 1001 transmits a fourth message to a first network device, the fourth message including AI capability information related to a second network device. Optionally, the transmitting unit 1001 further transmits a second message to the second network device, and the receiving unit 1002 further receives a first message transmitted by the first network device and/or receives a third message transmitted by the second network device. Or,

In some embodiments, the apparatus is configured in the first network device in the embodiments of the second aspect. The receiving unit 1002 receives a fourth message transmitted by a core network device, the fourth message including AI capability information related to a second network device. Optionally, the transmitting unit 1001 further transmits a first message to the core network device. Or,

In some embodiments, the apparatus is configured in the second network device in the embodiments of the second aspect. The transmitting unit 1001 transmits a third message to the core network device, the third message including AI capability information related to the second network device. Optionally, the receiving unit 1002 further receives a second message transmitted by the core network device.

In some embodiments, the apparatus may further include (not shown) a generating unit configured to generate the above messages. Reference may be made to the embodiments of the second aspect for how to generate, which shall not be repeated herein any further.

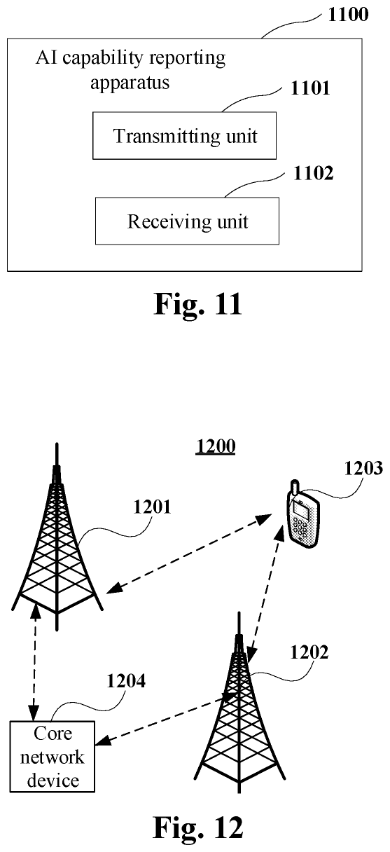

FIG. 11 is a schematic diagram of the AI capability reporting apparatus of the embodiments of this disclosure. The apparatus may be, for example, a terminal equipment, or one or some components or assemblies configured in the terminal equipment. As a principle of the apparatus for solving problems is identical to that of the method in the embodiments of the first aspect, reference may be made to the implementation of the method in the embodiments of the first aspect for implementation of this apparatus, with identical contents being not going to be repeated herein any further. As shown in FIG. 11, the apparatus 1100 includes: a transmitting unit 1101 and a receiving unit 1102.

In some embodiments, the transmitting unit 1101 transmits report information to a first network device, the report information including AI capability information of a first cell. Optionally, the transmitting unit 1101 may further transmit first UE capability information to the first network device, and the receiving unit 1102 may further receive configuration information transmitted by the first network device. The apparatus may further include (not shown) an acquiring unit configured to acquire AI capability information of the first cell.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 1200 may further include other components or modules, and reference may be made to related techniques for particulars of these components or modules.

According to the embodiments of this disclosure, the network device may acquire AI capability information related to a neighbor network device that has no direct interface via the terminal equipment or the core network device, so that an appropriate target cell is selected for the terminal equipment in mobility of the terminal equipment supporting AI, and the AI functionalities of the terminal equipment may be enabled as much as possible.

### Embodiments of a Fourth Aspect

The embodiments of this disclosure provide a communication system, including a network device and/or a terminal equipment, the network device including a first network device, a second network device, and/or a core network device.

FIG. 12 is a schematic diagram of the communication system of the embodiments of this disclosure. As shown in FIG. 12, the communication system 1200 may include a first network device 1201, a second network device 1202, a terminal equipment 1203, and a core network device 1204.

In some embodiments, the first network device 1201, the second network device 1202, the terminal equipment 1203 and the core network device 1204 are configured to execute the method described in the embodiments of the first or second aspect. As the method has been described in detail in the embodiments of the first or second aspect, the contents thereof are incorporated herein by reference, and shall not be repeated herein any further.

The embodiments of this disclosure further provide a terminal equipment.

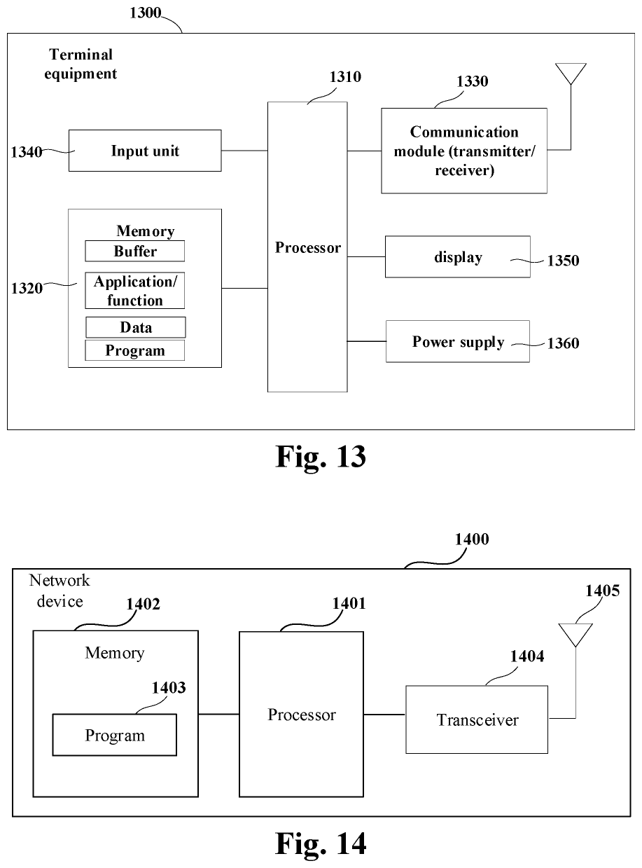

FIG. 13 is a schematic diagram of the terminal equipment of this embodiment. As shown in FIG. 13, the terminal equipment 1300 (such as corresponding to the terminal equipment 202 in FIG. 2) may include a processor 1310 and a memory 1320, the memory 1320 storing data and programs and being coupled to the processor 1310. It should be noted that this figure is illustrative, and other types of structures may also be used to supplement or replace this structure, so as to implement telecommunications functions or other functions.

For example, the processor 1310 may be configured to execute a program to carry out the method in the embodiments of the first aspect.

As shown in FIG. 13, the terminal equipment 1300 may further include a communication module 1330, an input unit 1340, a display 1350, and a power supply 1360. Functions of the above components are similar to those in the related art and shall not be repeated herein any further. It should be noted that the terminal equipment 1300 does not necessarily include all the components shown in FIG. 13, and the above components are not necessary. Furthermore, the terminal equipment 1300 may include components not shown in FIG. 13, and reference may be made to the related art.

The embodiments of this disclosure further provide a network device, which may, for example, be a base station or a CU or a DU or a core network device; however, this disclosure is not limited thereto, and it may also be another network device.

FIG. 14 is a schematic diagram of the network device of the embodiments of this disclosure. As shown in FIG. 14, the network device 1400 may include a processor 1401 and a memory 1402, the memory 1402 being coupled to the processor 1401. Wherein, the memory 1402 may store various data, and furthermore, it may store a program 1403 for information processing, and execute the program under control of the processor 1401.

In some embodiments, the functions of the apparatus 1000 may be integrated into the processor 1401, wherein the processor 1401 may be configured to carry out the method in the embodiments of the first or second aspect, the contents of which being incorporated herein, and being not going to be described herein any further.

In some other embodiments, the apparatus 1000 in the embodiments of the third aspect and the processor 1401 may be configured separately; for example, the apparatus 1000 in the embodiments of the third aspect may be configured as a chip connected to the processor 1401, and the functions of the apparatus 1000 in the embodiments of the third aspect are executed under control of the processor 1401.

Furthermore, as shown in FIG. 14, the network device 1400 may include a transceiver 1404, and an antenna 1405, etc., wherein functions of the above components are similar to those in the related art, and shall not be described herein any further. It should be noted that the network device 1400 does not necessarily include all the parts shown in FIG. 14, and furthermore, the network device 1400 may include parts not shown in FIG. 14, and the related art may be referred to.

Embodiments of this disclosure provide a computer program, which, when executed in a network device, will cause the network device to carry out the method described in the embodiments of the first or second aspect.

Embodiments of this disclosure provide a storage medium, including a computer program, which will cause a network device to carry out the method described in the embodiments of the first or second aspect.

The above network device may a first network device or a second network device or a core network device.

Embodiments of this disclosure provide a computer program, which, when executed in a terminal equipment, will cause the terminal equipment to carry out the method described in the embodiments of the first aspect.

Embodiments of this disclosure provide a storage medium, including a computer program, which will cause a terminal equipment to carry out the method described in the embodiments of the first aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 9 may either correspond to software modules of procedures of a computer program, or correspond to hardware modules. Such software modules may respectively correspond to the steps shown in FIG. 2. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 12 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.
1. An artificial intelligence (AI) capability reporting method, applicable to a terminal equipment (UE) side, wherein the method includes:
transmitting report information by the terminal equipment to a first network device, the report information including AI capability information of a first cell.
2. An artificial intelligence (AI) capability reporting method, applicable to a first network device side, wherein the method includes:
receiving, by the first network device, report information transmitted by a terminal equipment, the report information including AI capability information of a first cell.
3. An artificial intelligence (AI) capability reporting method, applicable to a core network device side, wherein the method includes:
transmitting a fourth message by the core network device to a first network device, the fourth message including AI capability information related to a second network device.
4. An artificial intelligence (AI) capability reporting method, applicable to a first network device side, wherein the method includes:
receiving, by the first network device, a fourth message transmitted by the core network device, the fourth message including AI capability information related to a second network device.
5. An artificial intelligence (AI) capability reporting method, applicable to a second network device side, wherein the method includes:
transmitting a third message by the second network device to a core network device, the third message including AI capability information related to the second network device.
6. A device, including a memory and a processor, the memory storing a computer program, and the processor being configured to execute the computer program to carry out the method as described in any one of supplements 1-4.
7. A communication system, characterized in that the communication system includes the device as described in supplement 6.

1. An artificial intelligence (AI) capability reporting apparatus, configured in a terminal equipment (UE), wherein the apparatus comprises:
transmitter circuitry configured to transmit report information to a first network device, the report information comprising AI capability information of a first cell.

2. The apparatus according to claim 1, wherein the first cell is a neighbor cell of a serving cell of the terminal equipment.

3. The apparatus according to claim 1, wherein the AI capability information comprises at least one piece of the following information:
support information of artificial intelligence;
support information of at least one AI-based feature or feature group;
support information of at least one functionality;
support information of at least one model;
association information of an AI-based feature or feature group and a functionality and/or a model; or
support information of at least one model transmission apparatus.

4. The apparatus according to claim 1, wherein the report information further comprises cell information of the first cell.

5. The apparatus according to claim 1, wherein the apparatus further comprises:
an acquiring unit configured to acquire AI capability information of the first cell.

6. The apparatus according to claim 5, wherein the acquiring unit reads a system message of the first cell to acquire AI capability information of the first cell.

7. The apparatus according to claim 1, wherein the transmitter circuitry further transmits first UE capability information to the first network device, the first UE capability information being used to indicate whether the terminal equipment supports a capability to acquire AI capability information of a cell.

8. The apparatus according to claim 1, wherein the apparatus further comprises:
a receiving unit configured to receive configuration information transmitted by the first network device, the configuration information comprising first indication information used to indicate that the terminal equipment reports AI capability information of the first cell.

9. The apparatus according to claim 8, wherein the configuration information further comprises cell information of the first cell and/or second indication information used to indicate AI capability information that the terminal equipment needs to report.

10. The apparatus according to claim 8, wherein the acquiring unit acquires AI capability information of the first cell according to the configuration information.

11. An artificial intelligence (AI) capability reporting apparatus, configured in a first network device, wherein the apparatus comprises:
a receiving unit configured to receive report information transmitted by a terminal equipment, the report information comprising AI capability information of a first cell, or receive a fourth message transmitted by a core network device, the fourth message comprising AI capability information related to a second network device.

12. An artificial intelligence (AI) capability reporting apparatus, configured in a core network device, wherein the apparatus comprises:
transmitter circuitry configured to transmit a fourth message to a first network device, the fourth message comprising AI capability information related to a second network device.

13. The apparatus according to claim 12, wherein the AI capability information comprises at least one piece of the following information:
support information of artificial intelligence;
support information of at least one AI-based feature or feature group;
support information of at least one functionality;
support information of at least one model;
association information of an AI-based feature or feature group and a functionality and/or a model; or
support information of at least one model transmission apparatus.

14. The apparatus according to claim 12, wherein the fourth message further comprises identification information of the second network device, and/or cell information under the second network device, and/or identification information of a distributed unit (DU) under the second network device.

15. The apparatus according to claim 12, wherein the fourth message comprises a handover command message or a handover failure message, wherein when the fourth message is a handover failure message, the fourth message further comprises handover failure cause information, wherein the handover failure cause information comprises at least one of:
not supporting at least one configuration of currently activated AI configuration information, AI not supported by a target cell, or
insufficient AI resources of a target cell,
wherein, the target cell belonging to the second network device.

16. The apparatus according to claim 12, wherein the apparatus further comprises:
a receiving unit configured to receive a third message transmitted by the second network device, the third message comprising AI capability information related to the second network device, and/or configured to receive a first message transmitted by the first network device, the first message comprising AI capability information of a terminal equipment.

17. The apparatus according to claim 16, wherein the third message comprises cell information under the second network device, and/or identification information of a DU under the second network device.

18. The apparatus according to claim 17, wherein the first message further comprises currently activated AI configuration information of the terminal equipment.

19. The apparatus according to claim 12, wherein the transmitter circuitry further transmits a second message to the second network device, the second message comprising AI capability information of a terminal equipment and/or currently activated AI configuration information of a terminal equipment.

20. The apparatus according to claim 16, wherein the third message comprises a handover request acknowledge message or a handover preparation failure message, wherein when the third message is a handover preparation failure message, the third message further comprises handover failure cause information, the handover failure cause information comprising at least one of: not supporting at least one configuration of currently activated AI configuration information, AI not supported by a target cell, or insufficient AI resources of a target cell; and/or the first message comprises a handover required message; and/or the second message comprises a handover request message.
